(19) United States
(12) Patent Application Publication
(10) Pub. No.: US 2025/0030072 A1
(43) Pub. Date: Jan. 23, 2025

(54) Battery Bank With a Safety Device and Method for Triggering the Safety Device

(71) Applicant: Bayerische Motoren Werke AKtiengesellschaft, Muenhen (DE)

(72) Inventors: Alexander ADAM, Muenchen (DE); Roland JUNG, Muenchen (DE); Sebastian SCHARNER, Tuerkenfeld (DE); Thomas WOEHRLE, Muenchen (DE)

(21) Appl. No.: 18/715,179

(22) PCT Filed: Nov. 23, 2022
(86) PCT No.: PCT/EP2022/083019

§ 371 Date: May 31, 2024

(30) Foreign Application Priority Data
Dec. 10, 2021 (DE) 10 2021 132 739.3

(51) Int. Cl. H01M 10/52; H01M 10/42; H01M 10/48; H01M 50/204; H01M 50/673

(52) U.S. Cl. CPC H01M 10/52; H01M 10/425; H01M 10/482; H01M 10/486; H01M 50/204; H01M 50/673; H01M 2010/4271

(57) ABSTRACT

A battery bank includes a bank housing and at least one battery cell, which is arranged within the bank housing and contains a sulphur-dioxide-based electrolyte. The battery bank has a safety apparatus with a metering device, which includes an additive for neutralizing the electrolyte and is configured to release the additive within the bank housing.

### BACKGROUND AND SUMMARY

The present invention relates to a battery bank having a safety apparatus and to a method for triggering the safety apparatus.

Electrochemical cells are of great significance in many technical fields. For example, electrochemical cells are used for mobile applications, such as for the operation of laptops, e-bikes or mobile phones. An advantage of electrochemical cells is that they can be connected to one another in series or in parallel, in order to form higher-energy batteries. Such batteries can be combined in what is referred to as a battery bank and are also suitable, inter alia, for high-voltage applications. For example, battery banks can make it possible to electrically drive vehicles or be used as stationary energy stores.

In the following text, the term “electrochemical cell” is used synonymously for all designations common in the prior art for rechargeable galvanic elements, such as cells, batteries, battery cells, accumulators, battery accumulators and secondary batteries.

An electrochemical cell is able to make electrons available for an external power circuit during a discharging operation. Conversely, an electrochemical call can be charged by the supply of electrons by means of an external power circuit during a charging operation.

An electrochemical cell has at least two different electrodes: a positive electrode (cathode) and a negative electrode (anode). Both electrodes are in contact with a separator, which is an electrical insulator. An example of a prior art separator is a porous polyolefin separator, which is impregnated with a liquid electrolyte composition. The separator separates the two electrodes from one another spatially and connects the two electrodes to one another ion-conductively.

The most commonly used electrochemical cell is the lithium-ion cell, also referred to as a lithium-ion battery. Lithium-ion cells from the prior art typically have a composite anode very often comprising a carbon-based anode active material, typically graphitic carbon, which is generally coated onto a metallic copper substrate foil with an electrode binder. Generally, the composite cathode comprises a positive cathode active material, for example a layered oxide, a binder and an electrical conductivity additive, which are for example deposited on a rolled aluminum collector foil. The layered oxide very often comprises LiCoO₂ or LiNi_{1/3}Mn_{1/3}Co_{1/3}O₂.

Typically, lithium-ion batteries comprise a liquid electrolyte composition, which ensures charge equalization between the cathode and the anode during the charging and discharging operations. The flow of current required for this is achieved by the transport of ions of a conductive salt in the electrolyte composition. In the case of lithium-ion cells, the conductive salt is a conductive lithium salt (for example LiPF₆, LiBF₄).

In addition to the conductive lithium salt, electrolyte compositions contain a solvent, which enables disassociation of the conductive salt and sufficient mobility of the lithium ions. Liquid organic solvents consisting of a selection of linear and cyclic dialkyl carbonates are known from the prior art. Use is generally made of mixtures of ethylene carbonate (EC), dimethyl carbonate (DMC), diethyl carbonate (DEC), propylene carbonate (PC) and ethyl methyl carbonate (EMC). The solvents cited here each have a specific stability range in which they operate stably at a given cell voltage. This range is also known as the voltage window. The electrochemical call can run stably during operation within the voltage window. On approaching the limits of the voltage window, electrochemical oxidation or reduction of the constituents of the electrolyte composition takes place. Efforts are therefore being made to use electrolytes which have a higher stability with respect to various cell voltages.

A further development of lithium-ion batteries with an organic electrolyte is therefore lithium-ion batteries with an inorganic electrolyte based on the solvent sulfur dioxide. Various approaches for stable electrolyte compositions based on sulfur dioxide are known in the prior art. Sulfur dioxide-based electrolyte compositions have in particular an increased ion conductivity and thus enable the operation of battery cells with high discharge currents without adversely affecting the stability of the cells. Furthermore, owing to their increased upper voltage limit, certain sulfur dioxide-based electrolyte compositions are suitable for constructing cells with a particularly high energy density. In particular, cells comprising a sulfur dioxide-based electrolyte have a higher voltage limit than cells comprising a conventional organic electrolyte and a conductive salt containing LiPF₆.

EP 1 201 004 B1 discloses a rechargeable electrochemical cell with a sulfur dioxide-based electrolyte. In this case, sulfur dioxide is not added as an additional substance, but instead constitutes the main constituent as solvent for the conductive salt in the electrolyte composition. Therefore, it should at least partially ensure the mobility of the lithium ions of the conductive salt, which bring about the transport of ions between the electrodes. In the proposed cells, lithium tetrachloroaluminate (LiAlCl₄) is used as conductive lithium-containing salt in combination with a cathode active material made of a transition metal oxide, in particular an intercalation compound such as lithium cobalt oxide (LiCoO₂). As a result of the addition of a salt additive, for example an alkali metal halide such as lithium fluoride, sodium chloride or lithium chloride, to the sulfur dioxide-containing electrolyte composition, functioning and rechargeable cells were obtained.

EP 2534719 B1 describes a rechargeable lithium battery cell comprising a sulfur dioxide-based electrolyte in combination with lithium iron phosphate (LFP) as cathode active material. The preferred conductive salt used in the electrolyte composition was lithium tetrachloroaluminate. In tests with cells on the basis of these components, it was possible to prove a high electrochemical stability of the cells.

WO 2015/043573 A2 describes a rechargeable electrochemical battery cell with a housing, a positive electrode, a negative electrode and an electrolyte containing sulfur dioxide and a conductive salt, at least one of the electrodes containing a binder selected from the group consisting of binder A, which consists of a polymer formed of monomer structural units of a conjugated carboxylic acid or of the alkali metal, alkali earth metal or ammonium salt of this conjugated carboxylic acid or the combination thereof, and binder B, which consists of a polymer based on monomer styrene and butadiene structural units, or a mixture of binders A and B.

WO 2021/019042 A1 describes rechargeable battery cells comprising an active metal, a layered oxide as cathode active material and a sulfur dioxide-containing electrolyte. Owing to the poor solubility of many conventional conductive lithium salts in sulfur dioxide, a conductive salt of formula M⁺[Z(OR)₄]⁻ was used in the cells, where M constitutes a metal selected from the group consisting of alkali metals, alkali earth metals and a metal from Group 12 of the Periodic Table of the Elements, and R is a hydrocarbon radical. The alkoxy groups —OR are each monovalently bonded to the central atom, which can be aluminum or boron. In a preferred embodiment, the cells contain a conductive perfluorinated salt of formula Li⁺[Al(OC(CF₃)₃)_{4]}⁻. Cells consisting of the components described exhibit stable electrochemical performance in experimental studies. In addition, the conductive salts, in particular the perfluorinated anion, have a surprising hydrolysis stability. The electrolytes should also be oxidation-stable to an upper potential of 5.0 V. It was also found that cells comprising the electrolytes disclosed can be discharged and charged at very low temperatures of down to −41° C.

German patent application no. 10 2021 118 811.3, unpublished on the priority date of the present application, also discloses a liquid electrolyte composition on the basis of sulfur dioxide for an electrochemical cell. The electrolyte composition comprises the following components: A) sulfur dioxide; B) at least one salt, the salt containing an anionic complex comprising at least one bidentate ligand. The counterion of the anionic complex is a metal cation, selected from the group consisting of alkali metals, alkali earth metals and metals of

Group 12 of the Period Table of the Elements. The central ion Z of the complex is selected from the group consisting of aluminum and boron. The bidentate ligand forms a ring with the central ion Z and with two oxygen atoms bonded to the central ion Z and the bridging group, the ring containing a continuous sequence of 2 to 5 carbon atoms. An electrochemical cell, in particular a lithium-ion cell, comprising the aforementioned electrolyte composition is furthermore proposed.

Cells comprising a sulfur dioxide-based electrolyte are furthermore known from EP 3 703 161 A1, EP 2 227 838 B1, EP 2 742 551 B1, EP 3 771 011 A2, WO 2005/031908 A2 and WO 2014/121803 A1, to which reference is made here.

A disadvantage of battery cells, in particular lithium-ion cells comprising a sulfur dioxide-based electrolyte composition, is the opening of the cell in the event of a mechanical, electrical or thermal defect of the cell. In the case of such an opening of the cell, release of electrolyte constituents from the cell, in particular gaseous electrolyte constituents such as sulfur dioxide, can occur.

This disclosure is based on the object of preventing transfer of the electrolyte into the surrounding area in the event of damage to a cell comprising a sulfur dioxide-based electrolyte.

The object may be achieved according to the invention by a battery bank comprising a storage housing and at least one battery cell comprising a sulfur dioxide-based electrolyte according to the independent claim.

Advantageous embodiments of the battery bank according to the invention are specified in the dependent claims, which can be selectively combined with one another.

According to the disclosure, the object may be achieved by a battery bank comprising a storage housing and at least one battery cell which is placed inside the storage housing and contains a sulfur dioxide-based electrolyte. The battery bank comprises a safety apparatus with a metering apparatus which comprises an additive for neutralizing the electrolyte and is designed to release the additive inside the storage housing.

The basic concept of the technology is that a battery bank comprises a safety apparatus, which neutralizes or binds a sulfur dioxide-based electrolyte emerging from a cell by releasing an additive, and thus prevents transfer of the electrolyte into the surrounding area.

The battery bank is preferably located in a vehicle and is used to electrically drive the vehicle. Of course, multiple battery banks may also be installed in such a vehicle.

Within the context of this disclosure, a battery bank means a storage housing, in the interior space of which at least one battery cell, preferably multiple battery cells, is/are placed. The battery cells may be connected to one another in the storage housing, in order to provide a higher energy.

A battery cell is understood to mean an electrochemical cell comprising a sulfur dioxide-based electrolyte. The battery cell is preferably a lithium-ion cell.

The technology is not further restricted in terms of the sulfur dioxide-based electrolyte composition. It is therefore possible to use any sulfur dioxide-based electrolyte compositions that are known in the prior art.

In particular, a sulfur dioxide-based electrolyte is understood to mean a liquid electrolyte composition which contains sulfur dioxide as constituent. The sulfur dioxide may be present in the electrolyte composition as a liquid, as a gas or bonded in a complex.

Suitable examples of such electrolyte compositions are known from EP 1 201 004 B1, EP 2534719 B1, WO 2015/043573 A2, WO 2021/019042 A1, EP 3 703 161 A1, EP 2 227 838 B1, EP 2 742 551 B1, EP 3 771 011 A2, WO 2005/031908 A2 and WO 2014/121803 A1 and also from German patent application no. 10 2021 118 811.3, unpublished on the priority date of the present application, to which reference is made here.

If the sulfur dioxide-based electrolyte emerges in the event of mechanical, thermal or electrical damage to the cell, the battery bank comprises a safety apparatus. The safety apparatus in turn comprises a metering apparatus which comprises an additive for neutralizing or binding the electrolyte and is designed to release the additive inside the storage housing. If the electrolyte emerges, said electrolyte can thus be safely neutralized directly and easily.

In the context of this disclosure, neutralization of the electrolyte is understood to mean chemical neutralization, which converts the electrolyte constituents into chemically more resistant, stable and non-toxic compounds.

In addition, the electrolyte is neutralized already in the storage housing of the battery bank so that transfer of the emerging electrolyte into the surrounding area can easily be prevented. Since the storage housing is sealed to prevent the escape of liquids, the additive, the electrolyte, the non-toxic reaction product created and other constituents remain in the battery bank after the neutralizing. The storage housing thus provides a defined reaction chamber in which the neutralization can be carried out under controlled conditions. Advantageously, the battery bank can be safely disposed of individually or fed to a recycling process after the neutralization has ended.

In one aspect of the disclosure, the additive comprises a base. The technology is not further restricted in terms of the base. In general, any bases that are known in the prior art can be used for the additive.

For example, the base can be a porous natural lime.

The base is preferably selected from the group consisting of carbonates, hydrogen carbonates, oxides and hydroxides, and combinations of these.

Carbonates used may be in particular metal carbonates, preferably alkali metal and alkali earth metal carbonates. Suitable examples of carbonates are barium carbonate, calcium carbonate, magnesium carbonate, potassium carbonate, sodium carbonate and zinc carbonate, and combinations of these.

Hydrogen carbonates used may be in particular metal hydrogen carbonates, preferably alkali metal and alkali earth metal hydrogen carbonates. Suitable examples of hydrogen carbonates include calcium hydrogen carbonate, magnesium hydrogen carbonate, barium hydrogen carbonate, sodium hydrogen carbonate and potassium hydrogen carbonate, and combinations of these.

Oxides used may in particular be metal oxides, preferably alkali metal and alkali earth metal oxides. Suitable examples of oxides include lithium oxide, sodium oxide, potassium oxide, magnesium oxide, calcium oxide, strontium oxide and barium oxide, and combinations of these.

Hydroxides used may be in particular metal hydroxides; alkali metal and alkali earth metal hydroxides preferably come into consideration. Examples of hydroxides include in particular lithium hydroxide, sodium hydroxide, potassium hydroxide, calcium hydroxide, barium hydroxide, strontium hydroxide and zinc hydroxide, and combinations of these.

The additive can also comprise water. The base is thus present in an aqueous solution. The base is preferably dissolved in the aqueous solution.

In another aspect of the disclosure, the aqueous solution may be a solution saturated by the base. Owing to the high base content, the saturated solutions have a particularly high ion concentration. The ion concentration (base concentration) preferably corresponds to the solubility product of the respective base. Owing to this, the solutions remain liquid even below the freezing point of water. The saturated solutions are thus suitable in particular for normal operation or use in a vehicle.

The additive particularly preferably comprises a saturated aqueous solution of sodium carbonate, further preferably an aqueous saturated solution of potassium carbonate, or combinations of these.

Providing a base in an aqueous solution makes it possible to chemically neutralize the sulfur dioxide-based electrolyte in the form of acid/base neutralization. The sulfur dioxide present in the electrolyte dissolves particularly readily in water and can therefore be absorbed and bound particularly quickly by the additive. The solubility of sulfur dioxide in water is 39.4 liters of sulfur dioxide per 1 liter of water at 20° C. and standard pressure. Sulfur dioxide reacts with water to form sulfuric acid, which can in turn react with the base in a neutralization reaction. The base can therefore convert the sulfur dioxide dissolved in the aqueous solution into more stable chemical compounds. For example, sulfur dioxide can be converted into stable sulfites (or sulfates) and/or hydrogen sulfites by carbonates.

Furthermore, the base used may not be toxic, may be readily soluble in water and may have excellent availability. Owing to the presence of the base in an aqueous medium, the latter can be easily released inside the storage housing by the metering apparatus. Thus, in the event of the electrolyte being released, the base dissolved in the aqueous solution can wet the battery cells inside the battery bank and thus prevent transfer of the electrolyte into the surrounding area.

In another aspect of the disclosure, the metering apparatus may comprise a storage vessel containing the additive and a pump connected to the storage vessel, the pump being connected via a valve to a distributing element. In this case, at least the distributing element is placed inside the storage housing.

The storage vessel is preferably placed outside the storage housing. It is also conceivable, however, for the storage housing to be placed in the interior space of the storage housing. The storage vessel serves to store the additive before the actual release. By way of the provision of a storage vessel containing the additive, the additive can be stored spatially separately from the battery cells.

The pump connected to the storage vessel is preferably a high-pressure pump. Furthermore, the pump is connected to a distributing element via a valve. The use of a pump, in particular a high-pressure pump, may enable quick transportation of the additive from the storage vessel into the distributing element and thus into the interior space of the storage housing. An efficient and quick release of the additive inside the storage housing may thus be ensured.

The technology is not further restricted in terms of the distributing element. In general, use can be made of any distributing elements known from the prior art that are suitable for releasing an additive, in particular an additive consisting of an aqueous solution having a base, inside a storage housing.

For example, the distributing element may comprise a line, preferably a flexible line, with nozzle outlets for distributing the additive. The nozzles preferably make it possible to atomize the additive, as a result of which the contact surface area between the additive and the emerging electrolyte is increased.

In another aspect of the disclosure, the safety apparatus may also comprise a monitoring device, where the monitoring device comprises a battery control system and a sensor unit connected to the battery control system.

The battery control system is preferably placed outside the battery bank. It is therefore conceivable that the battery control system monitors multiple battery banks. A sensor unit, which is preferably placed inside a storage housing, is connected to the battery control system.

In one embodiment, the sensor unit may be selected from the group consisting of optical sensors, pressure, temperature and chemical sensors.

In one embodiment, the sensor unit is a spectroscopic gas sensor for detecting gaseous sulfur dioxide.

In a preferred embodiment, the spectroscopic gas sensor is a nondispersive infrared sensor.

If at least one battery cell exhibits anomalous behavior during operation of the battery, this can be identified by the aforementioned types of sensor. A rise in pressure or temperature or a change in the composition of the atmosphere inside the storage housing can thus be detected by the sensor unit. A battery cell defect can thus be identified directly and without complications.

In particular a gas sensor selectively responding to sulfur dioxide enables direct information about the presence of sulfur dioxide inside the storage housing. If the gas sensor detects sulfur dioxide in the atmosphere of the storage housing, the sulfur dioxide-based electrolyte has emerged from the battery cell and the corresponding cell is thus defective.

The data collected by the sensor unit may be forwarded to the battery control system connected to the sensor unit. Typically, the data sent to the battery control system are measurement data that were collected over a certain period of time.

In another aspect of the disclosure, the battery control system may be configured to receive data from the sensor unit and evaluate them in terms of a triggering or non-triggering scenario.

The battery control system receives the data from the sensor unit and evaluate them in terms of the presence of a defect of a battery cell inside the storage housing. The battery control system takes the data as a basis to make a decision as to whether to initiate a triggering or non-triggering scenario. If the battery control system records anomalous data, more specifically data that differ from the data that are to be expected, the battery control system initiates a triggering scenario. If the data received from the sensor unit correspond to the data that are to be expected, a non-triggering scenario is selected.

In the event of a triggering scenario, the metering apparatus may be actuated by the battery control system so that the additive is released by the distributing element inside the storage housing. In the case of a non-triggering scenario, the status quo may be maintained and the metering apparatus may not be actuated.

The process described above preferably takes place at regular intervals. The monitoring device can thus monitor the battery cells in real time, and therefore anomalous data such as pressure, temperature and atmospheric parameters inside the storage housing can be detected immediately and reliably. The battery control system can therefore also immediately take measures to release the additive inside the battery bank to neutralize an emerging electrolyte.

A safety apparatus according to the disclosure which comprises a metering apparatus and a monitoring device may therefore be an active safety system. The safety apparatus may thus be able, in the event of an electrolyte emerging from a cell, to actively initiate countermeasures.

The technology also relates to a method for triggering a safety apparatus for a battery bank of the aforementioned type, the method comprising the following steps:
a) identifying, by means of the sensor unit of the monitoring device, emergence of the electrolyte from a battery cell inside the storage housing, from which data are compiled and forwarded to the battery control system,
b) evaluating the data by means of the battery control system in terms of the presence of a triggering or non-triggering scenario,
c) identifying a triggering scenario, and
d) actuating the metering apparatus, so that the additive is released inside the storage housing.

A safety apparatus with the aforementioned method can thus react immediately to an electrolyte emerging from a battery cell and take countermeasures. The sulfur dioxide-based electrolyte may therefore be reliably prevented from being transferred to the surrounding area.

The invention will be described in more detail below on the basis of exemplary embodiments with reference to the appended drawings.

### BRIEF DESCRIPTION OF THE DRAWINGS

FIG. 1 shows a schematic illustration of a battery bank comprising battery cells, a metering apparatus and a monitoring device;

FIG. 2 shows a schematic illustration of the battery bank from FIG. 1 during active operation in the event of an electrolyte emerging from a battery cell;

FIG. 3 shows a schematic illustration of a gas sensor for selectively detecting gaseous sulfur dioxide;

FIG. 4 shows an example of a suitable measurement range for the gas sensor from FIG. 3; and

FIG. 5 shows a schematic flow diagram of the steps of a method for triggering a safety apparatus for a battery bank.

### DETAILED DESCRIPTION OF THE DRAWINGS

FIG. 1 shows a battery bank 10 comprising a safety apparatus. The safety apparatus comprises a metering apparatus 34 and a monitoring device 36.

The battery bank 10 additionally comprises a storage housing 12 and multiple battery cells 14 placed in the interior space 40 of the storage housing 12. The storage housing 12 is in particular sealed to prevent the escape of liquids. For the controlled discharge of gases, the storage housing can also have a pressure-regulating valve or overpressure valve (not shown here).

At least one battery cell 14 is placed in the interior space 40. However, any desired number of battery cells may be placed inside the storage housing 12. In particular, the battery cells 14 may be connected to one another (not shown here), in order to make a higher-energy battery available. In addition, the placement of the battery cells 14 in the storage housing 12 is arbitrary and not further restricted.

The battery cells 14 contain at least one sulfur dioxide-based electrolyte. In general, the technology is not further restricted in terms of the battery cell 14 provided that the battery cell contains sulfur dioxide as electrolyte constituent.

For example, battery cells 14 comprising an electrolyte composition from WO 2021/019042 A1, WO 2015/043573 A2 or German patent application no. 10 2021 118 811.3, unpublished on the priority date of the present application, can be used.

The metering apparatus 34 comprises a storage vessel 26 containing the additive 16.

The storage vessel 26 contains an amount of the additive 16 that is sufficient to neutralize all the sulfur dioxide present in the battery cells 14. The storage vessel 26 preferably contains excess additive 16 with respect to the sulfur dioxide-based electrolyte present in the battery cells 14. This is advantageous in particular, because when the additive 16 is pumped away, a residual quantity of it usually remains behind in the storage vessel 26.

The storage vessel 26 is fluidically connected to a pump 22 via a line 24.

The pump 22 is further fluidically connected to a valve 20.

The valve 20 is inserted in the wall of the storage housing 12 and fluidically connects the interior space 40 of the storage housing 12 to the pump 22 and thus to the storage vessel 26.

A distributing element 18 which is placed inside the storage housing 12 is connected to the valve 20.

The distributing element 18 may be a rigid or flexible line. The distributing element 18 can be placed anywhere inside the storage housing 12. For example, it can be fixed to an inner wall of the storage housing 12 or else to an outer wall of a battery cell 14.

The distributing element 18 also has outlets (not shown here) for releasing the additive. The outlets may be in the form, for example, of nozzles which atomize the additive 16 to be released in the interior space 40 of the storage housing 12. The contact surface area between an emerging electrolyte and the additive 16 can thus be increased.

Furthermore, the safety apparatus comprises a monitoring device 36.

The monitoring device 36 comprises a battery control system 30 and a sensor unit 28, which is connected to the battery control system 30 and is placed inside the storage housing 12.

The sensor unit 28 may be placed anywhere inside the storage housing 12. It is therefore conceivable for the sensor unit 28 to be fixed to an inner wall of the storage housing 12. The sensor unit 28 may, however, also be fastened directly to a battery cell 14.

In a variant of the technology, multiple sensor units 28 may also be placed at any locations inside the storage housing 12. Various regions of the battery bank 10 can thus be monitored by the sensor unit 28.

The technology is not further restricted in terms of the sensor unit 28. It is possible to use any sensor units that are know in the prior art and are suitable for detecting a difference in pressure, temperature or atmosphere.

The sensor unit is preferably a sensor for selectively detecting sulfur dioxide, preferably gaseous sulfur dioxide, in an atmosphere. Any sensors known in the prior art can be used for this.

For example, an indicator known from U.S. Pat. No. 4,222,745 for detecting sulfur dioxide flowing out of a battery can be used. It consists of potassium dichromate adsorbed on finely divided silica and a polymeric adhesive material, for example polydimethylsiloxane, as stabilizing matrix. For intensive color perception, titanium dioxide can also be added. Upon contact with sulfur dioxide, this indicator changes color.

Also conceivable is a detector, known from WO 02 079 746, consisting of powdered potassium dichromate applied to an adhesive strip together with an oxidation accelerator and a metal oxide inhibitor, which makes it possible to detect, inter alia, sulfur dioxide.

A sensor for detecting gaseous sulfur dioxide is also known from U.S. Pat. No. 6,579,722, in the case of which a chemiluminescent reagent is immobilized in a polymer film. The chemiluminescence resulting from contact with sulfur dioxide is detected using a photomultiplier tube or a photoelectric element.

Use can also be made of a sensor from JP 2003035705, which is suitable for detecting sulfur dioxide in a gaseous sample, in the case of which sensor the optical transmission in the UV/VIS/IR range is tracked under the action of analytes. The sensor consists of a combination of orange-1 and amines and also a combination of iron ammonium sulfate, phenanthroline and acids.

EP 0 585 212 also discloses a sensor which is in the form of a sensor membrane for detecting sulfur dioxide. For this, use is made of transition metal complexes comprising rubidium, osmium, iridium, rhodium, palladium, platinum or rhenium as central atom; 2,2′-bipyridine, 1,10-phenanthroline or 4,7-diphenyl-1,10-phenanthroline as ligand; and perchlorate or chloride or sulfate as counter-anion. The polymer matrix comes from the group consisting of cellulose derivatives, polystyrenes, polytetrahydrofurans or derivatives of these.

Use can also be made of a sensor from EP 0 578 630, which provides a sensor membrane of optical sensors for detecting sulfur dioxide. For this, pH indicators, such as the fluorescent dye quinine or the absorption dye bromocresol purple, are immobilized with counter-ions, such as long-chain sulfonate ions or ammonium ions with long-chain radicals, in a polymer matrix of polyvinyl chloride.

An optical sensor for selectively detecting gaseous sulfur dioxide is particularly preferably used.

For example, use can be made of an optical sensor as is known from “Optical sensors for dissolved sulfur dioxide” (A. Stangelmayer, I. Klimant, O. S. Wolfbeis, Fresenius J., Analytical Chemistry, 1998, 362, 73-76). To detect gaseous sulfur dioxide, lipophilic pH indicators in the form of ion pairs immobilized in a gas-permeable silicon or ormosil membrane are used as sulfur dioxide sensors for gaseous samples. The pH indicators used here are ditetraalkylammonium salts with long-chain alkyl radicals of bromothymol blue, bromocresol purple and bromophenol blue. The absorption of light in the UV/VIS range is used as measurement variable.

It is also possible to use an optical sensor for quantitative identification of sulfur dioxide in a sample, as is known from DE 10 2004 051 924 A1. The sensor proposed here contains an indicator substance, which is homogeneously immobilized in a matrix of the transparent sensor, comes into at least indirect contact with the sample and changes its concentration in the presence of sulfur dioxide. This change in concentration of the indicator substance can be tracked by photometry as a change in the transmission of light in the UV/VIS range of the sensor.

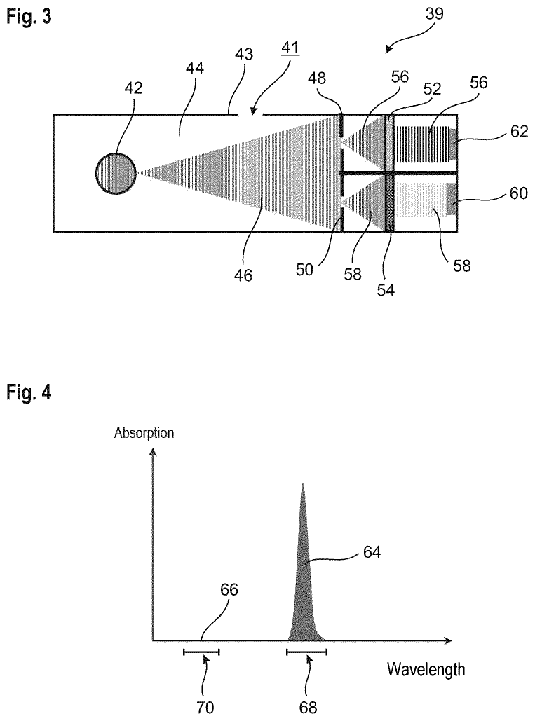

In a particularly preferred variant, the sensor for selectively detecting sulfur dioxide is a sensor as described in FIG. 3.

The sensor unit 28 is designed to detect emergence of the electrolyte from a battery cell 14, to compile data therefrom and to forward them to the battery control system 30. The data flow from the sensor unit 28 to the battery control system 30 via a data line 33.

The battery control system 30 is placed outside the storage housing 12 and electrically connected to the sensor unit 28 via the data line 33. The data line 33 is preferably configured to transfer electrical signals and thus data.

The battery control system 30 is able to receive the data from the sensor unit 28 and to evaluate them in terms of a triggering or non-triggering scenario. If the battery control system records anomalous data in terms of a change in temperature, pressure or atmosphere inside the storage housing 12, the battery control system 30 initiates a triggering scenario.

The battery control system 30 is electrically connected to the pump 22 via a connection 32. In the event of a triggering scenario, the battery control system 30 can selectively actuate the pump 22 so that the pump 22 is activated and extracts the additive 16 from the storage vessel 26. The additive 16 thus leaves the storage vessel 26 via the lines 24, the pump 22 and via the valve 20 and enters the distributing element 18, which lastly releases the additive 16 inside the storage housing 12.

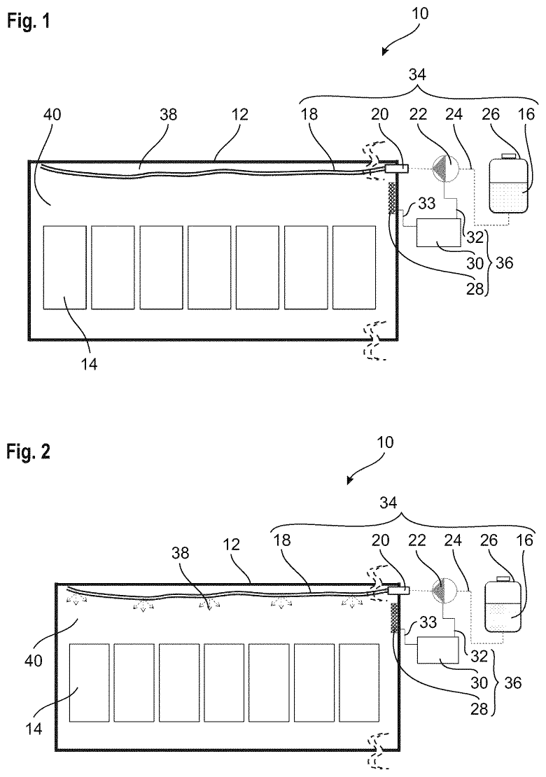

FIG. 2 shows the battery bank from FIG. 1 in the event of a triggering scenario.

Furthermore, FIG. 2 contains the same components as were described in FIG. 1.

A description of the mechanism of a triggering scenario will be given below.

If damage to at least one battery cell 14 occurs, the sulfur dioxide-based electrolyte emerges from the damaged cell. Damage to a cell can also occur without the cell opening at the same time. In both cases, however, a parameter in the interior space of the storage housing 12, such as temperature, pressure or composition of the atmosphere, will necessarily change. A change in these parameters is detected by a sensor unit 28.

If, by way of example, in the case of a cell opening, the sulfur dioxide-based electrolyte emerges, the latter also accumulates in the atmosphere of the storage housing 12 and can thereupon be detected by a sensor unit 28 set to atmospheric parameters.

The sensor unit 28 detects the presence of an electrolyte inside the storage housing 12 in the form of differing parameters relating to pressure, temperature or composition of the atmosphere and forwards the anomalous parameters to the battery control system 30 in the form of data. The battery control system 30 continuously compares the data received with data that are to be expected. If a difference between the received data and the data that are to be expected is found, the battery control system 30 initiates a triggering scenario. The additive 16 is thereupon released from the storage vessel 26 by the pump 22 and via the distributing element 18. The released additive 38 can thus wet the interior space 40 of the storage housing 12, come into contact with the sulfur dioxide-based electrolyte and react therewith in a neutralization reaction, in particular an acid/base neutralization reaction, as a result of which transfer of the electrolyte into the surrounding area is prevented.

FIG. 3 shows a sulfur dioxide sensor on the basis of a twin-beam spectrometer.

The gas sensor 39 has a detector chamber 44 enclosed by a detector housing 43. Furthermore, the detector housing 43 has a gas inlet opening 41.

The gas inlet opening 41 fluidically connects the detector chamber 44 to the interior space 40 of the storage housing. This makes it possible for a free gas exchange to take place between the two regions and an emerging electrolyte in the storage housing 12 to be detected by the gas sensor 39.

The detector housing 43 has an elongate form, a light source 42 being assigned to one end inside the housing.

The light source 42 is preferably an infrared light source, particularly preferably a near-infrared light source. The technology is not restricted in terms of the infrared light source. Any IR light sources known in the prior art can be used, provided they can emit at wavelengths suitable for detecting sulfur dioxide in a gas atmosphere.

The light source 42 preferably emits at wavelengths in the range between 400-1800 cm⁻¹, particularly preferably between 450-600 cm⁻¹, 1100-1200 cm⁻¹ and/or 1300-1400 cm⁻¹. During operation, the light source 42 emits an NIR beam 46 with a continuous spectrum of wavelengths in the aforementioned range.

The NIR beam 46 emitted by the light source 42 is split into two spatially separate NIR beams by a measurement-beam stop 48 placed in the detector chamber 44 and a reference-beam stop 50. More specifically, the NIR beam 46 is split into a measurement beam 56 by the measurement-beam stop 48 and a reference beam 58 by the reference-beam stop 50. Two separate beam paths are thus created by the stops.

After it passes through the measurement-beam stop 48, the measurement beam 56 is incident on a measurement-beam filter 52. After it passes through the reference-beam stop 50, the reference beam 58 is incident on a reference-beam filter 54.

Suitable measurement-beam filters 52 and the reference-beam filter 54 are, for example, bandpass filters, preferably narrow-band filters. For example, the bandpass filters may have a bandwidth of 10-0.2 nm, preferably 5-0.2 nm, particularly preferably 2-0.2 nm. They are thus able to selectively filter a predefined wavelength out of the reference beam 58 and the measurement beam 56.

As reference, the transmission region of the reference-beam filter 54 is selected such that it is permeable in a narrow range of the spectrum in which neither sulfur dioxide nor other molecules, such as carbon dioxide or water vapor, have absorption bands.

For the measurement-beam filter 52, which is to say that for the measurement beam 56, the transmission range is selected such that it falls within a range where only sulfur dioxide, but not other gases that could distort the measurement signal, is/are absorbed.

Examples of suitable wavelengths of the measurement-beam filter are: 1.56 μm, 1.57 μm, 1.58 μm, 2.46 μm and 4.02 μm.

After passing through the measurement-beam filter 52, the measurement beam 56 is incident on a measurement-beam detector 62 downstream of the measurement-beam filter 52. Similarly, the reference beam 58 is incident on a reference-beam detector 60 downstream of the reference-beam filter 54.

To detect the wavelengths allowed through by the filters, for example, thermocouple-based detectors are suitable. They are able to convert heat energy directly into electrical energy, as a result of which very small thermal stresses can be generated and thus detected. The detectors used in this way thus operate particularly precisely and are suitable for detecting even small amounts of sulfur dioxide in an atmosphere.

FIG. 4 shows a measurement range of a sulfur dioxide sensor from FIG. 3, absorption being plotted against a wavelength. The sum total of the absorption of the measurement-beam and reference-beam detectors 60, 62 is illustrated.

The measurement-beam detector 62 detects the measurement signal 64 in a measurement wavelength range 68, while the reference-beam detector 60 detects the reference signal 66 in a reference wavelength range 70. The reference wavelength range 70 and measurement wavelength range 68 are predefined by the choice of beam filter. Similarly, the width of the measured wavelength ranges depends on the choice of beam filter and is generally 10-0.2 nm, preferably 5-0.2 nm, particularly preferably 2-0.2 nm.

If the measurement-beam detector 62 detects a measurement signal 64, there is sulfur dioxide in the atmosphere of the detector chamber 44 and thus also in the interior space of the storage housing 12. For positive evidence of sulfur dioxide, a threshold value typically above the background noises of the detector can be defined.

The advantage of the twin-beam spectrometers illustrated is that they are compact and thus can be accommodated inside the storage housing 12 with a saving on space. In addition, sulfur dioxide is detected by spectroscopy, and therefore the evaluation and conversion to electronic information is made easier in comparison with conventional methods.

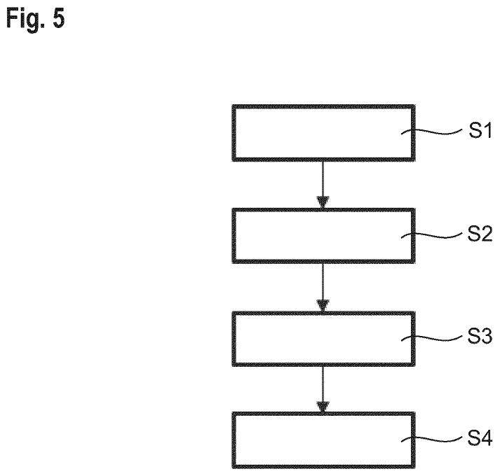

FIG. 5 shows a schematic flow diagram of the steps of a method for triggering a safety apparatus for a battery bank.

In the first step, emergence of an electrolyte from a battery cell is identified. The identification is done by means of a sensor unit of the monitoring device, the sensor unit being placed inside the storage housing. The sensor unit compiles data and sends them to the battery control system (step S1).

After this, the data are evaluated by the battery control system in terms of the presence of a triggering or non-triggering scenario (step S2). In so doing, the battery control system evaluates the parameters measured by the sensor unit by comparing them with the parameters that are to be expected.

If the parameters differ and this difference is outside a tolerance range, a triggering scenario is performed (step S3). The tolerance range depends on various factors, such as the selection of the detector or form of the beam path, and therefore must be selected depending on the structure of the battery bank or the gas sensor.

Finally, the metering apparatus is actuated in that the battery control system activates a pump so that the pump extracts the additive from the storage vessel and releases it via the valve and the distributing element inside the storage housing (step S4).

1-10. (canceled)

11. A battery bank comprising:
a bank housing and one or more battery cells positioned within the bank housing, each battery cell containing a sulfur dioxide-based electrolyte; and
a safety apparatus with a metering device comprising an additive for neutralizing the electrolyte, the metering device being configured to release the additive inside the bank housing.

12. The battery bank according to claim 11, wherein the additive comprises a base and is present in an aqueous solution.

13. The battery bank according to claim 12, wherein the base is selected from the group consisting of carbonates, hydrogen carbonates, oxides and hydroxides, and combinations of these.

14. The battery bank according to claim 11, wherein
the metering device comprises a storage vessel containing the additive and a pump connected to the storage vessel, the pump being connected via a valve to a distributing element positioned inside the bank housing.

15. The battery bank according to claim 11, wherein
the safety apparatus further comprises a monitoring device, the monitoring device comprising a battery control system and a sensor unit connected to the battery control system.

16. The battery bank according to claim 15, wherein
the sensor unit is selected from the group consisting of an optical sensor, a pressure sensor, a temperature sensor, and a chemical sensor.

17. The battery bank according to claim 15, wherein
the sensor unit comprises a spectroscopic gas sensor for detecting gaseous sulfur dioxide.

18. The battery bank according to claim 15, wherein
the sensor unit is configured to detect emergence of the electrolyte from the one or more battery cells, to compile data therefrom and forward the data to the battery control system.

19. The battery bank according to claim 18, wherein
the battery control system is configured to receive the data from the sensor unit and evaluate the data in terms of a triggering or non-triggering scenario.

20. The battery bank according to claim 19, wherein
the battery control system is configured, in the event of a triggering scenario, to actuate the metering device, whereby the additive is released by the distributing element inside the bank housing.

21. A method for triggering a safety apparatus for a battery bank, the method comprising:
providing the battery bank according to claim 20;
detecting, via the sensor unit of the monitoring device, emergence of the electrolyte from the one or more battery cells inside the bank housing;
compiling, via the sensor unit, data from the detection and forwarding the data to the battery control system;
evaluating, via the battery control system, the data from the detection in terms of the presence of a triggering or non-triggering scenario; and
upon identification of a triggering scenario, actuating the metering apparatus, whereby the additive is released inside the bank housing.
